(19) United States
(12) Patent Application Publication
(10) Pub. No.: US 2020/0215917 A1
(43) Pub. Date: Jul. 9, 2020

(54) METHOD FOR OPERATING A DRIVER ASSISTANCE SYSTEM OF A TRANSPORTATION VEHICLE AND TRANSPORTATION VEHICLE

(71) Applicant: VOLKSWAGEN AKTIENGESELLSCHAFT, Wolfsburg (DE)

(72) Inventors: Volkmar SCHÖNING, Wedemark (DE); Frank HÜSEMANN, Cremlingen (DE)

(21) Appl. No.: 16/637,519

(22) PCT Filed: Aug. 2, 2018
(86) PCT No.: PCT/EP2018/070926

§ 371 Date: Feb. 7, 2020

(30) Foreign Application Priority Data
Aug. 15, 2017 (DE) 10 2017 214 225.1

(51) Int. Cl. B60K 35/00; B60W 50/14; B60W 40/09

(52) U.S. Cl. CPC B60K 35/00; B60W 50/14; B60W 40/09; B60K 2370/171; B60W 2050/146; B60K 2370/167; B60K 2370/334; B60K 2370/177; B60K 2370/1529

(57) ABSTRACT

A method for operating a driver assistance system of the transportation vehicle to assist a driver while the transportation vehicle is travelling. A virtual transportation vehicle is displayed to the driver of the transportation vehicle on at least one display element wherein the virtual transportation vehicle is varied in respect of its size and/or position and/or its appearance on the display element while the virtual transportation vehicle is displayed on the display element. A transportation vehicle having a driver assistance system.

### PRIORITY CLAIM

This patent application is a U.S. National Phase of International Patent Application No. PCT/EP2018/070926, filed 2 Aug. 2018, which claims priority to German Patent Application No. 10 2017 214 225.1, filed 15 Aug. 2017, the disclosures of which are incorporated herein by reference in their entireties.

### SUMMARY

Illustrative embodiments relate to a method for operating a driver assistance system of a transportation vehicle while the transportation vehicle is being driven and also to a transportation vehicle comprising a driver assistance system.

### BRIEF DESCRIPTION OF THE DRAWINGS

An exemplary embodiment is described below. In the drawing:

FIG. 1 shows a schematic view of a cockpit of a transportation vehicle which has a display element by which or on which a virtual transportation vehicle is shown; and

FIG. 2 shows a schematic view of the cockpit according to FIG. 1, wherein the virtual transportation vehicle is displayed by the display element and illustrates departure from a lane by use of a turn signal.

### DETAILED DESCRIPTION

A method for operating a driver assistance system of a transportation vehicle while the transportation vehicle is being driven is already known from US 2015/0291160 A1. A virtual transportation vehicle is displayed to the driver of the transportation vehicle on at least one display element during driving. Here, the virtual transportation vehicle is displayed to the driver when a real transportation vehicle is in convoy, provided that the real transportation vehicle is not detected for at most one defined time interval by a detection device of the transportation vehicle after the transportation vehicle is detected. After the defined time interval, the virtual transportation vehicle is screened out. As an alternative, the virtual transportation vehicle is also screened out when the real transportation vehicle is detected by the detection device.

Furthermore, DE 10 2013 207 546 A1 discloses a system for testing a distance control apparatus of a transportation vehicle. The system has a manipulation unit which is designed to generate a virtual object which is located in front of the transportation vehicle. Furthermore, the manipulation unit is designed to manipulate a sensor signal of a distance sensor device in such a way that data of the manipulated sensor signal represent the virtual object which is located in front of the transportation vehicle. A transportation vehicle speed of the transportation vehicle can be influenced by a distance control apparatus of the system, wherein the distance control apparatus is designed to generate an actuating signal for influencing at least one actuating element for the transportation vehicle speed.

Furthermore, DE 10 2011 050 341 A1 discloses a transportation vehicle speed control apparatus, wherein a distance between a transportation vehicle and a transportation vehicle which is located in front of the transportation vehicle in the direction of travel is ascertained with the aid of a virtual transportation vehicle.

Disclosed embodiments provide a method for operating a driver assistance system of a transportation vehicle while the transportation vehicle is being driven and also a transportation vehicle comprising a driver assistance system by which the driver of the motor transportation vehicle can be beneficially assisted while driving.

This is achieved by a method and also by a transportation vehicle.

A first disclosed embodiment relates to a method for operating a driver assistance system of a transportation vehicle while the transportation vehicle is being driven. In the method, a virtual transportation vehicle is displayed to the driver of the transportation vehicle on at least one display element.

To now be able to assist the driver while driving the transportation vehicle in a particularly beneficial manner, in particular, for steering or guiding the transportation vehicle, according to the disclosed embodiments provision is made, to assist the driver, for the virtual transportation vehicle to be varied in terms of its size and/or position and/or its appearance on the display element while the virtual transportation vehicle is being displayed on the display element. This means that the virtual transportation vehicle is continuously displayed on the display element while the transportation vehicle is being driven in the event of or as a result of activation of the driver assistance system. In this case, the virtual transportation vehicle can be produced on a windshield of the transportation vehicle or on a so-called combiner, that is to say imaged thereon, wherein the combiner can be arranged on the windshield. In other words, the display element can be designed as a windshield or as a combiner of the transportation vehicle. The virtual transportation vehicle is an illustration of a transportation vehicle which is displayed on the display element in a field of view of the driver of the transportation vehicle. The virtual transportation vehicle may be, for example, a three-dimensional illustration of the transportation vehicle or a pictogram of the transportation vehicle. A variation in the virtual transportation vehicle in terms of its size is to be understood to mean that it can be displayed in different sizes for the purpose of assisting the driver. For example, the virtual transportation vehicle is illustrated smaller for characterizing an acceleration operation which is to be carried out than for characterizing a braking operation which is to be carried out.

If the intention is to display to the driver that he should reduce the speed of the transportation vehicle, a situation of getting close to the virtual transportation vehicle can be illustrated to the driver by dynamically increasing the size of the virtual transportation vehicle to trigger braking by the driver. For example, an increase in the distance between the virtual transportation vehicle and the transportation vehicle can be illustrated by dynamically reducing the size of the virtual transportation vehicle, so that the driver of the transportation vehicle is prompted to increase a speed of the transportation vehicle. A variation in the position of the virtual transportation vehicle for the purpose of assisting the driver is to be understood to mean that the virtual transportation vehicle can be displayed to the driver of the transportation vehicle in different positions to prompt the driver to steer the transportation vehicle in a direction which is prespecified by the position of the virtual transportation vehicle. For example, cornering which is to be carried out can be proposed to the driver of the transportation vehicle by a change in the position of the virtual transportation vehicle relative to the display element. In the case of the virtual transportation vehicle on the display element, the appearance is intended to be understood to be a manner of illustration or a configuration (design) of the virtual transportation vehicle in terms of its shape and/or color. In this case, the variation in the appearance is intended to be understood to mean that the virtual transportation vehicle is continuously displayed on the display element and in so doing is changed in respect of its shape and/or in respect of its color at least in regions.

A particularly beneficial manner of driving the transportation vehicle, which the driver can implement when steering the transportation vehicle, can be proposed to the driver by the method. The beneficial manner of driving can be communicated to the driver of the transportation vehicle in a particularly simple and particularly understandable manner by the virtual transportation vehicle. Furthermore, a large amount of driving information, which the driver is intended to take into consideration when steering the transportation vehicle, can be communicated to the driver of the transportation vehicle in a particularly simple and clear manner by the virtual transportation vehicle. The driving information may be, for example, a speed limit and/or traffic conditions and/or a proposed route of a navigation system of the transportation vehicle.

In a disclosed embodiment, it has been found to be beneficial when the virtual transportation vehicle is varied in respect of its appearance in such a way that, while at least one first subregion of the virtual transportation vehicle is being displayed on the display element and there is no variation in the first subregion, at least one second subregion of the virtual transportation vehicle, which second subregion is different from the first subregion, is varied.

In other words, the first subregion of the virtual transportation vehicle is constantly displayed in the same shape, color, position and size, while the second subregion of the virtual transportation vehicle is varied in terms of its shape and/or its size and/or its color and/or its position at least once, in particular, several times at defined time intervals. In this way, a turn signal or an activated hazard warning light system of the virtual transportation vehicle can be illustrated, for example. The route which is ascertained by the navigation device can be displayed to the driver by way of showing the activated turn signal. Showing the activated hazard warning light system allows the attention of the driver of the transportation vehicle to be particularly beneficial drawn to a hazardous situation.

The virtual transportation vehicle may be projected onto the display element in a visual axis of the driver by a projection device. Here, the projection device may be a head-up display. A head-up display is used to produce an image which is projected onto the display element and is also called a virtual image. In the present case, the virtual image is the virtual transportation vehicle. Projection of the virtual transportation vehicle into the visual axis of the driver has the benefit that the driver can look at a road on which the transportation vehicle is traveling and at the same time can see the virtual transportation vehicle while steering the transportation vehicle. A particularly high level of safety can be achieved in this way since the driver does not have to look away from the road to see the virtual transportation vehicle.

In a further disclosed embodiment, provision is made for at least a current location of the transportation vehicle to be ascertained, wherein the virtual transportation vehicle is displayed depending on the ascertained location. In this case, the current location of the transportation vehicle can be ascertained, for example, by coordinates of the transportation vehicle. By way of example, the Global Positioning System (GPS), Galileo, Beidou or the Global Satellite Navigation System (GLONASS) can be used for this purpose. A country which is associated with the ascertained location and or an associated region can be ascertained depending on the coordinates. This allows the virtual transportation vehicle to be output to the driver of the transportation vehicle by the display element in a country-specific and/or region-specific manner depending on the ascertained location. As a result, country-specific traffic regulations and/or region-specific traffic regulations can be transmitted to the driver of the transportation vehicle in a particularly simple manner by displaying the virtual transportation vehicle in a corresponding manner.

In a further disclosed embodiment, provision is made for the driver to be assisted by varying the virtual transportation vehicle when changing lanes and/or when leaving a road and/or when forming an emergency corridor and/or when driving around an object. For example, the driver is assisted when changing lanes and/or leaving the road and/or forming the emergency corridor and/or driving around the object by way of a change in position of the transportation vehicle relative to the road on which it is traveling being illustrated, and therefore proposed, to the driver by varying the position of the virtual transportation vehicle relative to the display element. As an alternative or in addition, changing lanes and/or leaving the road and/or forming the emergency corridor and/or driving around the object can be proposed to the driver by way of the virtual transportation vehicle being shown with an activated turn signal. The activated turn signal can be shown, for example, by way of at least the first subregion of the virtual transportation vehicle being displayed on the display element and there being no variation in the first subregion, while the at least one second subregion of the virtual transportation vehicle, which second subregion is different from the first subregion, is varied. This has the benefit that the driver can be made aware in a particularly simple manner that it is advisable to change lanes and/or leave the road and/or form the emergency corridor and/or drive around the object.

In a further disclosed embodiment, provision is made for the virtual transportation vehicle to be displayed, in particular, varied, depending on a selected driving profile of the transportation vehicle. Here, the driving profile is to be understood to mean a driving behavior of the driver of the transportation vehicle which corresponds to a driving style. The driving profile may be, for example, a particularly energy-efficient driving behavior (economy driving profile), a particularly smooth and calm driving behavior (family driving profile) and/or a particularly dynamic driving behavior (sport driving profile). The driving profile can be selected, for example, by the driver of the transportation vehicle and the virtual transportation vehicle can be displayed, in particular, varied, depending on a selection made by the driver in terms of the driving profile. Displaying, in particular, varying, the virtual transportation vehicle can illustrate the energy-efficient driving behavior and/or the smooth driving behavior and/or the dynamic driving behavior, so that the respective selected driving behavior is proposed to the driver of the transportation vehicle depending on the traffic situation. Therefore, the driver of the transportation vehicle can match the assistance by the driver assistance system as desired in terms of the driving behavior by the selection he makes.

In this context, it has proven to be beneficial when a driving behavior of the driver is ascertained, wherein the virtual transportation vehicle is displayed, in particular, varied, depending on the ascertained driving behavior of the driver of the transportation vehicle. This means that the driving behavior of the driver in different traffic situations is ascertained and is then stored. The ascertained driving behavior of the driver is included by the driver assistance system when displaying or varying the virtual transportation vehicle. Therefore, assistance of the driver by the virtual transportation vehicle can be matched to the ascertained driving behavior of the driver. This allows a particularly high level of convenience for the driver since he can be assisted by the driver assistance system in accordance with his driving behavior.

In a further disclosed embodiment, provision is made for at least one environmental parameter which characterizes at least one part of the environment of the transportation vehicle to be detected by at least one environmental sensor, wherein the virtual transportation vehicle is displayed, in particular, varied, depending on the environmental parameter. The environmental parameter may be, for example, a lane guide of a road on which the transportation vehicle is traveling. Here, the virtual transportation vehicle can be displayed in terms of its position relative to the display element, for example, depending on the lane guide of the road on which the transportation vehicle is traveling, in such a way that an arrangement of the virtual transportation vehicle on the road in front of the transportation vehicle is illustrated. As an alternative, the environmental parameter may be a road user located in the environment of the transportation vehicle. Consequently, the environmental parameter can be included in displaying or varying the virtual transportation vehicle in such a way that the assistance of the driver by the driver assistance system includes the further road user. In this case, the driver of the transportation vehicle can be assisted by varying the virtual transportation vehicle in terms of avoiding and/or braking and/or stopping at a defined distance from the further road user. Therefore, a particularly high level of traffic safety can be provided by assisting the driver.

It has been found to be further beneficial when at least one further image is displayed on the display element next to the virtual transportation vehicle. The further image may be, for example, a pictogram and/or a symbol and/or a virtual road user. A particularly large amount of information can be displayed to the driver of the transportation vehicle in a particularly simple manner in this way.

A second disclosed embodiment relates to a transportation vehicle comprising a driver assistance system which is designed to carry out a method according to the first disclosed embodiment.

Disclosed embodiments also include developments of the disclosed transportation vehicle which have features as have already been described in connection with the developments of the disclosed method. For this reason, the corresponding developments of the disclosed transportation vehicle are not described again here.

In the exemplary embodiment, the described components of the embodiment are each individual features that should be considered independently of one another and each also develop the disclosed embodiments independently of one another, and therefore can also be regarded as a constituent part of the disclosure individually or in a combination other than that shown. Furthermore, the described embodiment can also be supplemented by further features of the disclosed embodiments which have already been described.

In the figures, elements having the same function are each provided with the same reference signs.

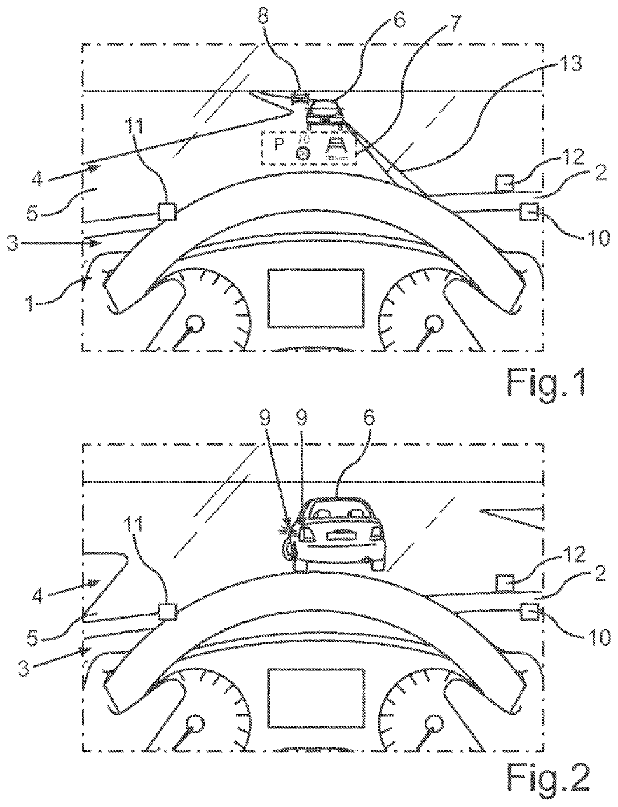

FIG. 1 and FIG. 2 each show a schematic view of a perspective of a driver 1 of a transportation vehicle 2 along a direction of travel of the transportation vehicle 2 in the longitudinal direction of the transportation vehicle toward the front from a cockpit 3 of the transportation vehicle 2 into an environment 4 of the transportation vehicle 2. Here, a display element 5, which is a windshield of the transportation vehicle 2 in the present case, is situated in a visual axis or in the field of view of the driver 1. The driver 1 can look through this display element 5 into the environment 4 of the transportation vehicle 2. At the same time, a virtual image element can be projected onto the display element 5, which virtual image element the driver 1 can perceive when looking into the environment 4 of the transportation vehicle 2. In the present case, a virtual transportation vehicle 6 is displayed to the driver 1 on the display element 5. Furthermore, a further virtual image 7 is displayed on the display element 5 in FIG. 1 in addition to the virtual transportation vehicle 6, which further virtual image informs the driver 1 of a maximum speed, a driving situation and also a navigation instruction. In the present case, the driving situation is a real road user 8 located in front of the transportation vehicle 2 and the relative speed of the road user and transportation vehicle in relation to one another. In the illustration shown in FIG. 2, the virtual transportation vehicle 6 is shown with an activated turn signal 9 by the display element 5. Here, the activation of the turn signal 9 can be shown by the display element 5 by way of the subregion of the turn signal 9 being varied at least once, in particular, several times at defined time intervals, while a remainder of the virtual transportation vehicle 6, which remainder is different from the turn signal 9, is shown continuously in an unchanged manner or is varied independently of the turn signal 9.

Furthermore, the transportation vehicle 2 comprises a driver assistance system 10 which is schematically illustrated by a box both in FIG. 1 and in FIG. 2 and by which the driver 1 can be assisted while driving the transportation vehicle 2. To this end, the driver assistance system 10 is connected to a projection device 11 of the transportation vehicle 2, by which projection device the virtual transportation vehicle 6 can be projected onto the display element 5. To assist the driver 1, the virtual transportation vehicle 6, which is projected by the projection device 11, can be varied in terms of its size and/or position and/or its appearance on the display element 5 by the driver assistance system 10 while the virtual transportation vehicle 6 is being displayed on the display element 5. A change in the direction of travel can be proposed to the driver 1 of the transportation vehicle 2 by way of the virtual transportation vehicle 6 being varied by way of being shown to the driver 1 from different viewing angles.

In the present case, the driver assistance system 10 is connected to the projection device 11, which is a head-up display, to a navigation device, to a road sign recognition device, to a memory for country-specific traffic regulations and also to a memory for adaptive driving profiles.

Furthermore, the transportation vehicle 2 can comprise an environmental sensor 12 by which an environmental parameter which characterizes at least one part of the environment 4 of the transportation vehicle 2 can be detected. The virtual transportation vehicle 6 can then be displayed, in particular, varied, depending on the environmental parameter. In the present case, a lane 13 is detected by the environmental sensor 12 using a lane guide, and the virtual transportation vehicle 6 is projected onto the display element 5 by the projection device 11 in such a way that the virtual transportation vehicle 6 appears to be located on the lane 13 to the driver 1 of the transportation vehicle 2.

In this case, assistance of the driver 1 by the driver assistance system 10 is based on the idea that it is exhausting to drive on a substantially empty motorway for a long time or to get oriented on a winding country road in the dark. Furthermore, it is exhausting to drive in an unknown city or to keep an eye on all displays of the transportation vehicle 2 to behave correctly in traffic. Furthermore, it should always be remembered that a family of the driver 1 would like to travel particularly calmly. Furthermore, situation-dependent hazards should be noted.

In contrast to this, it is convenient to drive behind another road user 8 in a convoy since this other road user 8 forms a stable reference point in a traffic situation. This is possible provided that a driving behavior of the other road user 8 corresponds to a driver's own driving style. Furthermore, traveling in a convoy provides meaningful assistance to the driver 1 since automatic driving is not permitted at present and/or automatic driving in certain traffic infrastructures is not yet reliable at present.

The virtual transportation vehicle 6 is a three-dimensional projection into a visual axis of the driver 1 on the head-up display. An extremely wide variety of information can be combined in one display, which can also be intuitively understood across all languages and cultures, by the virtual transportation vehicle 6. Longitudinal control and lateral control of the transportation vehicle 2 can remain the responsibility of the driver 1 of the transportation vehicle 2. Assistance of the driver 1 can be switched on as required and passengers are not affected by it.

To assist the driver 1 with longitudinal control of the transportation vehicle 2, the virtual transportation vehicle 6 can be dynamically reduced in size and/or lifted dynamically along a transportation vehicle vertical direction z in position for the purpose of illustrating an acceleration, to thereby illustrate an increasing distance between the transportation vehicle 2 and the virtual transportation vehicle 6. To prompt the driver 1 of the transportation vehicle 2 to decelerate or to brake, the virtual transportation vehicle 6 can be dynamically increased in terms of its size and/or dynamically lowered in position along the transportation vehicle vertical direction z on the display element 5 by the projection device 11, so that a reduction in distance and therefore catching up to the virtual transportation vehicle 6 is illustrated to the driver 1. The driver 1 of the transportation vehicle 2 can be assisted in terms of lateral control by way of a recommended change in lane when turning being illustrated on the display element 5 by a virtual turn signal on the virtual transportation vehicle 6 and/or by a change in position of the virtual transportation vehicle 6 along a transportation vehicle lateral direction y. As an alternative or in addition, cornering can be illustrated to the driver 1 by a change in position of the virtual transportation vehicle 6 along the transportation vehicle lateral direction y.

To inform the driver 1 of a hazard, the virtual transportation vehicle 6 can be alternately shown and not shown on the display element 5 at least in regions within short time intervals. As an alternative or in addition, a warning triangle can be alternately shown and not shown on the display element 5 within short time intervals. Furthermore, a recommended manner of behavior in a special situation can be shown by the virtual transportation vehicle 6 by way of a move to the left or to the right for forming an emergency corridor being illustrated to the driver 1 by the virtual transportation vehicle 6.

This has the benefit that the driver 1 can react to a respective traffic situation at a particularly early stage. Furthermore, it is beneficial for the assistance of the driver by the driver assistance system 10 to be able to be switched on as required and for the virtual transportation vehicle 6 to be displayed only in a visual axis of the driver 1, so that passengers are not affected by the virtual transportation vehicle 6. Furthermore, warnings and instructions, as may be provided by an attentive passenger, can be integrated on the display element 5 by the projection device 11. This may be incorporation of text reading “Caution: speed cameras” and/or “Children sleeping”. Technical implementation is beneficial scalable from very simple in the case of employing a combined head-up display to very high quality in the case of employing an augmented reality head-up display with a three-dimensional projection.

In principle, a large amount of different driving information is calculated and displayed in different ways by driver assistance systems. In the case of a virtual convoy, this driving information should be projected into the virtual transportation vehicle 6. To this end, the driver assistance system 10 can be connected to the navigation device to assist the driver 1 by varying the virtual transportation vehicle 6 when changing lanes and/or when leaving a road and/or when forming the emergency corridor and/or when driving around an object. Furthermore, the driver assistance system 10 is connected to the traffic sign recognition device, so that acceleration and/or steady driving and/or deceleration are proposed to the driver 1 by the virtual transportation vehicle 6 depending on a traffic sign which is recognized by the traffic sign recognition device. Moreover, the driver assistance system 10 is connected to a night-vision device, as a result of which the driver 1 is assisted by the virtual transportation vehicle 6 when cornering at night and also in the case of hazards on a country road on which the transportation vehicle 2 is located. Furthermore, the driver assistance system 10 is connected to the memory in which country-specific traffic regulations are stored. In connection with the country-specific traffic regulations, the driver assistance system 10 can, after ascertaining a current location of the transportation vehicle 2, assist in varying the virtual transportation vehicle 6 in accordance with the country-specific traffic regulations, in the present case in respect of speed levels and giving priority to buses. Furthermore, the virtual transportation vehicle 6 can vary in accordance with an adaptive driving profile, which is selected by the driver 1 of the transportation vehicle 2, by the driver assistance system 10. In the present case, the respective driving profile may be an energy-saving economy driving profile or a dynamic sport driving profile or a smooth and calm family driving profile. In this case, the respective driving profile can be set by the driver 1 and a new driving behavior can be learnt by the driver 1 by simulating the respective driving profile which is prespecified by the virtual transportation vehicle 6.

Using the example of the economy driving profile, in which a particularly large amount of fuel can be saved, anticipatory driving can be simulated. If a red stop light is detected by the environmental sensor 12, for example, by a camera device, the virtual transportation vehicle 6 can illustrate a dynamic reduction in a distance between the virtual transportation vehicle 6 and the transportation vehicle 2, and this can lead to the driver 1 releasing the accelerator at an early stage. In this way, the driver 1 can be prompted to use a braking effect of an engine of the transportation vehicle 2. Furthermore, the navigation device knows a route of the transportation vehicle 2 and is informed that there is a village after the next bend and early reduction to a speed which is suitable for driving through a village is desirable. This can be proposed to the driver 1 by way of a reduction in the distance between the virtual transportation vehicle 6 and the transportation vehicle 2 being illustrated, so that the driver 1 releases the accelerator at an early stage. If the traffic sign recognition device which is coupled to the driver assistance system 10 identifies a no-overtaking regulation and a real further transportation vehicle which is traveling more slowly than the transportation vehicle 2 is traveling in front of the transportation vehicle 2, an overtaking process is not illustrated to the driver 1 by the virtual transportation vehicle 6 on account of the no-overtaking regulation even though the driver assistance system 10 is aware of a particularly fast driving behavior of the driver 1.

When traveling with a family, a moderate driving style should be maintained. Particularly high acceleration values are uncomfortable for passengers in the rear of the transportation vehicle 2 since the passengers in the rear usually cannot have an overview of a traffic situation and reactions of the driver 1 occur unexpectedly. For this reason, acceleration values of below 0.3 g (g-force), which corresponds to a comfortable range, should be maintained. A maximum acceleration value of the transportation vehicle 2 can be received by the driver 1 by the driver assistance system 10 and included in the variation of the virtual transportation vehicle 6. The virtual transportation vehicle 6 then behaves exactly as is desired by the family or by passengers. This can prevent the driver 1 from lapsing into his usual manner of driving at acceleration values which may be excessive.

As an alternative or in addition, a driving behavior of the driver 1 can be ascertained by the driver assistance system 10 and the virtual transportation vehicle 6 can be displayed, in particular, varied, depending on the ascertained driving behavior of the driver 1. The driver assistance system 10 stores the driving behavior of the driver 1 in defined traffic situations and varies the virtual transportation vehicle 6 in the same or similar traffic situations depending on the stored driving behavior of the driver 1.

Overall, the example shows how a follow-me assistant can be provided to thereby allow the driver 1 to be assisted by the driver assistance system 10 while driving the transportation vehicle 2.

### LIST OF REFERENCE SIGNS

1 Driver
2 Transportation vehicle
3 Cockpit
4 Environment
5 Display element
6 Virtual transportation vehicle
7 Image
8 Road user
9 Activated turn signal
10 Driver assistance system
11 Projection device
12 Environmental sensor

1. A method for operating a driver assistance system of a transportation vehicle while the transportation vehicle is being driven by a driver, the method comprising:
displaying a virtual transportation vehicle to the driver of the transportation vehicle on at least one display element;
varying size and/or position and/or appearance of the virtual transportation vehicle on the display element to assist the driver.

2. The method of claim 1, wherein the virtual transportation vehicle includes at least one first subregion and at least one second subregion, wherein the appearance of the virtual transportation vehicle in the second subregion is varied while the appearance of the virtual transportation vehicle in the first reason has no variation.

3. The method of claim 1, wherein the virtual transportation vehicle is projected onto the display element into a visual axis of the driver by a projection device.

4. The method of claim 1, further comprising ascertaining at least a current location of the vehicle, and displaying the virtual transportation vehicle based on the ascertained location.

5. The method of claim 1, wherein the driver assistance includes varying display of the virtual transportation vehicle when the transportation vehicle is changing lanes and/or when the transportation vehicle is leaving a road and/or when the transportation vehicle forms an emergency corridor and/or when the transportation vehicle is driving around an object.

6. The method of claim 1, wherein the variation of the displayed virtual transportation vehicle is based on a selected driving profile of the transportation vehicle.

7. The method of claim 1, further comprising ascertaining a driving behavior of the driver, wherein the variation of the displayed virtual transportation vehicle is based on the ascertained driving behavior of the driver of the transportation vehicle.

8. The method of claim 1, further comprising detecting at least one environmental parameter which characterizes at least one part of the environment of the transportation vehicle by at least one environmental sensor, wherein the display of the virtual transportation vehicle is varied based on the detected environmental parameter.

9. The method of claim 1, further comprising displaying at least one further image on the display element next to the virtual transportation vehicle.

10. A transportation vehicle comprising a driver assistance system configured to provide driver assistance for a driver of the transportation vehicle while the transportation vehicle is being driven by the driver, the system including at least one display element, wherein a virtual transportation vehicle is displayed to the driver of the transportation vehicle on the at least one display element, and the size and/or position and/or appearance of the virtual transportation vehicle is varied on the display element to assist the driver.

11. The transportation vehicle of claim 10, wherein the virtual transportation vehicle includes at least one first subregion and at least one second subregion, wherein the appearance of the virtual transportation vehicle in the second subregion is varied while the appearance of the virtual transportation vehicle in the first reason has no variation.

12. The transportation vehicle of claim 10, wherein the virtual transportation vehicle is projected onto the display element into a visual axis of the driver by a projection device.

13. The transportation vehicle of claim 10, wherein at least a current location of the transportation vehicle, and the virtual transportation vehicle is displayed based on the ascertained location.

14. The transportation vehicle of claim 10, wherein the driver assistance includes varying display of the virtual transportation vehicle when the transportation vehicle is changing lanes and/or when the transportation vehicle is leaving a road and/or when the transportation vehicle forms an emergency corridor and/or when the transportation vehicle is driving around an object.

15. The transportation vehicle of claim 10, wherein the variation of the displayed virtual transportation vehicle is based on a selected driving profile of the transportation vehicle.

16. The transportation vehicle of claim 10, wherein a driving behavior of the driver is ascertained and the variation of the displayed virtual transportation vehicle is based on the ascertained driving behavior of the driver of the transportation vehicle.

17. The transportation vehicle of claim 10, further comprising at least one environmental sensor configured to detect at least one environmental parameter which characterizes at least one part of the environment of the transportation vehicle, wherein the display of the virtual transportation vehicle is varied based on the detected environmental parameter.

18. The transportation vehicle of claim 10, wherein at least one further image is displayed on the display element next to the virtual transportation vehicle.
